(19) United States
(12) Patent Application Publication
(10) Pub. No.: US 2004/0073561 A1
(43) Pub. Date: Apr. 15, 2004

(54) Method for autonomously searching a plurality of non-related databases residing on inter and intra networks with the intent to locate a plurality of documents containing a plurality of desired parameters and to communicate with the owners of said documents for the purpose of engaging said owners in a transaction

(75) Inventors: Susan Torres, Dana Point, CA (US); William Price, Santa Ana, CA (US); Reginald Dupre, Encinitas, CA (US); Carlos Pardo, Santa Ana, CA (US)

Correspondence Address: Dana Quest, Suite 475, 24843 Del Prado, Dana Point, CA, 92629, US

(73) Assignee: Dana Quest Inc., Dana Point, CA

(21) Appl. No.: 10/647,314

(22) Filed: Aug. 26, 2003

Related U.S. Application Data
(60) Provisional application No. 60/405,890, filed on Aug. 26, 2002.

(51) Int. Cl. G06F 17/00

(52) U.S. Cl. 707/100

(57) ABSTRACT

The present invention is a method for locating works such as music, graphic images, or text files contained on databases or residing as individual files on private or public networks. This invention will, once it locates an object conforming to the parameters specified by the user, initiate an automated dialog with the owner of the conforming object for the purpose of determining the intentions of the owner. This invention lends itself to searching for documents, images, sounds, or other resources that may already be owned by the user but not known to him or for documents, images, sounds, or other resources that are available on the Internet and are freely accessible or documents, images, sounds, or other resources that are available on databases located on the Internet where the owner or controller of the document requires a fee to access the document.

### CROSS-REFERENCE TO RELATED APPLICATIONS

Not Applicable

### STATEMENT REGARDING FEDERALLY SPONSORED RESEARCH OR DEVELOPMENT

Not Applicable. No federal funds were involved in the development of this invention.

### REFERENCE TO SEQUENCE LISTING, A TABLE, OR COMPUTER PROGRAM LISTING COMPACT DISK APPENDIX

Not Applicable

### BACKGROUND OF THE INVENTION

1. Field of Invention

The field of the present invention relates to intelligent data driven network agents.

2. Background of the Invention

Modern search engines are generally accessed and used through the use of a client program running on a desktop PC and commonly referred to as a browser. These browsers provide a graphical interface for viewing content residing on client computer systems such as desktop PCs and for viewing content residing on computers connected to private and public networks. Users of these browser programs often access search engines or programs residing on other computers. These search engines allow the user to specify a number of keyword parameters and/or select parameters through the use of drop down lists and through the use of selecting items and terms shown on the display of the browser.

Once a search engine has been given the terms of a search, it typically accesses a database that has indexes containing keywords and pointers to objects or documents referenced by the keywords. The search engine will then assemble a list of pointers to the documents or objects that have been located and displays the list to the user. The user can then typically select one of the located documents and have the browser display the document on the computer display device or terminal.

Search engines are each typically concerned with special areas of interest. For example, some search engines are setup to search for telephone numbers. Some search engines are setup to search for automobiles for sale and some search engines search for job postings. Some search engines are general in nature and will sometimes present a list of other search engines. Google.com is such a generalized search engine. Google.com has the ability to return individual items of interest as well as links or pointers to other search engines.

The use of some search engines are free, such as Google.com and some search engines charge fees for providing some of their search capabilities. For example, a search engine named Monster.com allows free access to people who are searching for jobs. Monster.com allows people to enter a resume into the Monster.com database but does not make the collection of a resume a requirement for accessing the Monster.com job database. Monster.com however does charge companies or employers a fee to enter a job into the Monster.com database and charge a fee to employers to search the Monster.com resume database.

Likewise, another large search engine with both free and for fee services is eBay.com. eBay.com allows users or buyers to initiate free searches for items for sale. Ebay.com allows sellers of items, for a fee, to enter a description of the item into the eBay.com database for display to users. EBay.com also provides other fee services to buyers and sellers outside of the fee charged to sellers for display of information for items for sale.

It is the intent of the present invention to provide an enhanced intelligent agent capable of locating resources or objects by making use of data and rule sets provided by the user. The invention does not, unlike typical search engines, maintain it's own database. The invention will locate user described objects and perform searches for the object without having built-in direct knowledge of the desired resource or the owner of the resource and will, once the resource has been located, intelligently decide if the resource meets the requirements of the user prior to contacting the resource owner and facilitating a transaction.

### SUMMARY OF THE INVENTION

It is the object of this invention to allow users to specify sets of meta-data that describe some object (document, static or moving graphic image, or audio) or service or resource that the user desires to own or use. The invention will search the user's client computer system and both public and accessible private networks and make a list of all objects that meet the first plurality of parameters contained in the meta-data. The invention will then apply a plurality of user meta-data that contains a set of rules against which the located objects are filtered to exclude those resources that do not conform to the plurality of rules. Owners of objects that meet the plurality of parameters and pass the plurality of rules are then contacted automatically to verify that their object is still available for use or sale. Those objects still available are compiled in a list and shown to the user of the invention. The user may then select none, all, or some portion of the objects that he wants the invention to facilitate a transaction between himself and the owner of the object.

### BRIEF DESCRIPTION OF THE DRAWINGS

FIG. 1 is a depiction of the system level block diagram of this invention. This figure depicts a client workstation, a private client network server, 2 network servers accessible over a public network, and 3 object or resource owners.

FIG. 2 shows the individual sets of meta-data provided by the user to the invention. This figure depicts 5 sets of meta-data data. Meta-Data Set 1 (200) contains the parameters to be used to search for objects. These parameters may be textual in nature or may consist of static or moving graphic images or may consist of video images or may consist of digital audio sounds. Meta-Data Set 2 (201) contains rules to be used to search for the objects described by Meta-Data Set 1 (200). These rules may consist of parameters describing how closely object(s) must match the descriptions contained in Meta-Data Set 1 (200) and may consist of directions that describe how the method can access resources such as fee based services and may consist of directions that describe how the method can negotiate it's way through secure access control points or gateways. Meta-Data Set 3 (202) consists of sets of filters or algorithms that describe to the method how it can further filter the number of found objects resulting in a list of objects that closely meet the objectives of the user. Meta-Data Set 4 (203) consists of rules that describe to the method how it is to contact the owner of a resource that has passed the filtering algorithms of Meta-Data Set 3 (202). Meta-Data Set 5 (204) consists of rules that describe to the method how it is to negotiate with the owner of the resource who responded to a contact initiated through the use of Meta-Data Set 4 (203).

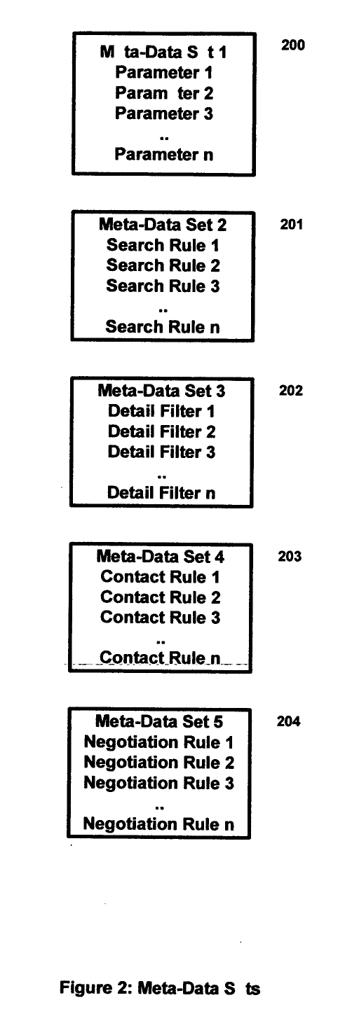

FIG. 3 shows the lists of information generated by the method as a result of it using Meta-Data Set 1 (200) through Meta-Data Set 5 (204). Preliminary Search Results (300) is a list of objects found as a result of the method using Meta-Data Set 1 (200) and Meta-Data Set 2 (201). This list of objects is returned to the client's computer Workstation (101). Filtered Results (301) is a list of objects that have been filtered by the method using Meta-Data Set 3 (202). This list of objects is returned to the client's computer Workstation (101). Contact Results (302) is a list of objects where the objects owners have replied to an initial contact by the method as a result of Meta-Data Set 4 (203). This list of objects is returned to the client's computer Workstation (101). Negotiation Results (303) is a list of objects where the objects owners have responded to the method that negotiated for the use or purchase of the object as a result of the method using Meta-Data Set 5 (204). This list of objects is returned to the client's computer Workstation (101).

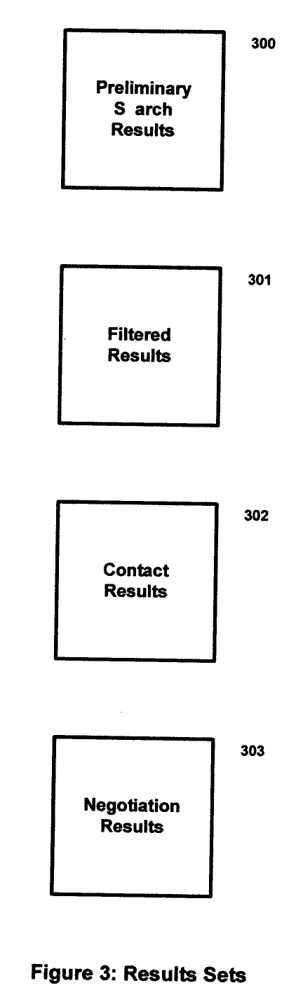

### DETAILED DESCRIPTION OF THE INVENTION

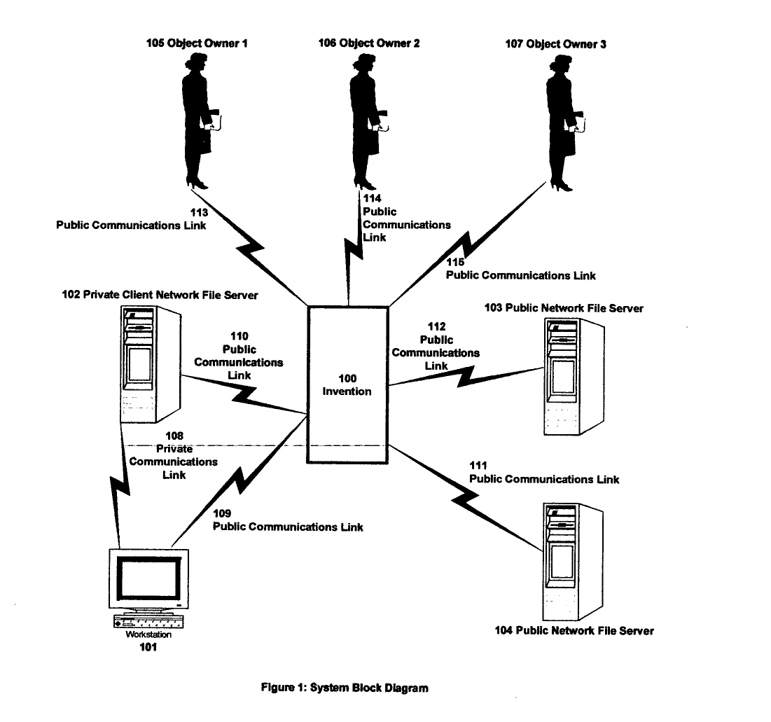

Referring to FIG. 1, User Workstation (101) communicates with Invention (100) through Public Communications Link (109). User Workstation (101) also communicates with Private Client Network File Server (102) via Private Communications Link (108). Invention (100) communicates with Private Client Network File Server (102) via Public Communications Link (110). Communications links 108, 109, 110, 111, 112, 113, 114, and 115 are understood to be public and/or private networks. For example, Communications Link (108) is part of a private network to which only User Workstation (101) and Private Client Network File Server (102) have access. Communications Links (109) through (115) are part of public networks that allow for Invention (100) to communicate with Public Network File Servers (103) and (104) and with Object Owner 1 (105), Object Owner 2 (106), and Object Owner 3 (107).

The user of this invention will contact the Invention (100) via Public Communications Link (109) and establish a work session. The user, via Workstation (101) will compose a plurality of meta-data sets consisting of Meta-Data Set 1 (200), Meta-Data Set 2 (201), Meta-Data Set 3 (202), Meta-Data Set 4 (203), and Meta-Data Set 5 (204). These sets of data are used by Invention (100) to direct it in finding, performing first and second levels of filtering, contacting the owners of resources and/or objects, and negotiating with the owner(s) of the resources and/or object(s) being sought.

These sets of data are Meta-Data Set 1 (200) that contains a set of search parameters that Invention (100) uses when attempting to locate the resource and/or object desired by the user. These search parameters may consist of textual or document type data used for searching for documents, static or moving graphical images used to search for those types of images, video images used to search for those types of images, or digital audio samples used to search for such things as speech, sounds, and music. The search parameters contained in Meta-Data Set 1 (200) gives the method the power of acting like a powerful search engine without the restrictions of current search engine methodologies. Meta-Data Set 2 (201) contains sets of rules defining how the method utilizes the search parameters contained in Meta-Data Set 1 (200). Meta-Data Set 2 (201) rules, for example, may direct Invention (100) to search Private Client Network File Server (102) via Public Communications Network (110) for object(s) being sought. If Private Client Network File Server (102) requires user identification codes and/or passwords for access, then Meta-Data Set 2 (201) will contain those data items and instructions telling the method how they are to be used. In general, for every secure access system Meta-Data Set 2 (201) directs the method to use, it will include the information and instructions necessary for the method to access the secure system. This information and instructions may include Universal Resource Locators (URLs), logon instructions including but not be limited to user Identification and Passwords and information and instructions for using the resources located on Private Client Network File Server (102).

Meta-Data Set 2 (201) may for example, direct Invention (100) to contact a public search engine via Public Communications Link (112) such as Google.com residing on Public Network File Server (103) and perform a search using Meta-Data Set 1 (200) parameters as the Google.com search parameters and information and instructions for using the resources located on Google.com to perform the search.

Meta-Data Set 2 (201) rules may for example, direct Invention (100) to contact a fee based job search engine such as Monster.com, HotJobs.com, Career.com, etc. and perform a search for employee resumes using Meta-Data Set 1 (200) parameters as the job search parameters. If Meta-Data Set 2 (201) rules direct Invention (100) to use the services of a fee based service, the rules will also provide sufficient information and instructions to allow Invention (100) to logon to the fee based service and use the resources located on the fee based service to perform the search.

Meta-Data Set 2 (201) rules may for example, direct Invention (100) to search public news groups such as those found on Usenet and other news group type services such as those found on Yahoo.com and perform searches for objects using Meta-Data Set 1 (200) parameters as the object search parameters. If Meta-Data Set 2 (201) rules direct Invention (100) to use the services of one or more public news groups, the rule that provides the direction will also provide sufficient information and instructions to Invention (100) to allow Invention (100) to use the resources of the news group.

Invention (100) will construct a Preliminary Search Results (300) list of objects that were located through the use of Meta-Data Set 2 (201) Search Rules and Meta-Data Set 1 (200) Search Parameters. Invention (100) will then apply Meta-Data Set 3 (202) Detail Filter rules, against Preliminary Search Results (300) list of objects resulting in a list of second order filtered objects, Filtered Results (301).

Invention (100) will then use Meta-Data Set 4 (203) Contact Rules to make an initial contact with the owners of the located resources and/or objects. For example, Meta-Data Set 4 (203) may direct the method to send a message to the owner of a located resource and/or object. The format and method of deliver of the message may be but not be limited to one or more of the following: email, page, computer generated printed paper letter delivered via United States Postal Office, instant message delivered over the Internet, Short Message Service (SMS) delivered via a cell phone or pager, or a computer generated audio call delivered via standard telephone networks. The point being that the method will attempt to contact the owner of a located resource and/or object notifying the owner that someone desired to acquire the use or the ownership of the resource and/or object.

Invention (100) will then collect responses from the contacted owners of located resources and/or objects into Contact Results (302). After a period of time has elapsed as specified by Meta-Data Set 4 (203), Invention (100) will apply Meta-Data Set 5 (204) against Contact Results (302) and contact the owners of resources and/or objects that responded in a positive manner to the initial contact with a specific offer and instructions for transfer of use or ownership of the located resources and/or objects.

Invention (100) will then collect responses to the negotiation from the contacted owners of located resources and/or objects into Negotiation Results (303).

For example, when Invention (100) applies Meta-Data Set 5 (204) Negotiation Rules, against Contact Results (302), Meta-Data Set 5 (204) Negotiation Rules may direct Invention (100) to conduct an interactive session where Invention (100) is directed by the rules to display Contact Results (302) on the user's Workstation (101) where the user may eliminate unwanted objects by directing Invention (100) to delete or remove them from Contact Results (302).

Negotiation Rules contained in Meta-Data Set 5 (204) may direct Invention (100) to send an email containing an offer to acquire to the owner of each found object requesting the owner to reply within a time period as specified by the Negotiation Rules contained in Meta-Data Set 5 (204). The Negotiation Rules may further specify that all returned email responses are to be sent to the user or to Invention (100). If all responses are to be returned to the user then Invention (100) will send the contact message to the object owners and the process for the session is completed. If all of the responses are to be returned to Invention (100), Invention (100) will collect the responses during the allowed period of time. When the allotted time for responses has expired, Invention (100) will process the responses according to Negotiation Rules contained in Meta-Data Set 5 (204).

For example, Negotiation Rules contained in Meta-Data Set 5 (204) may direct Invention (100) to conduct an interactive session to display responses to the user where the user will manually select the object(s) for use or purchase. Or, Negotiation Rules contained in Meta-Data Set 5 (204) may direct Invention (100) to forward the responses to the user after which the process for the session will be complete. Or, Negotiation Rules contained in Meta-Data Set 5 (204) may direct an interactive session where Invention (100) is directed to display the email responses to the user where the user will manually select the object(s) for use or purchase after which Invention (100) will send another email to the object owner specifying an offer of the user. Negotiation Rules contained in Meta-Data Set 5 (204) may further direct Invention to arrange via email a meeting with the object owner or schedule a telephone conversation with the object owner.

Once the Negotiation Rules contained in Meta-Data Set 5 (204) have all been processed, the processing for the session will have been completed.

What is claimed is:

1. A method implemented on a programmed computer system connected to a public access communications network where the method receives a plurality of lists of meta-data from a remote user's computer system connected to the same public access communications network where the said meta-data:
a. Contains rules for directing the method in how to use resources contained on other programmed computer systems connected to public access communications networks through the use of secure communications devices requiring a protected sequence of operations to be performed to allow access outside of the secure private communications network.
b. Contains rules for directing the method in how to use resources residing on other programmed computer systems connected to the same public access communications network.
c. Contains rules for directing the method in how to filter the results of operations performed at it's request by resources residing on other programmed computer systems connected to the same public access communications network.
d. Contains rules for directing the method in how to contact owners of resources and objects located at it's request by resources residing on other programmed computer systems connected to the same public access communications network.
e. Contains rules for directing the method in how to negotiate for the use or ownership of said resources and objects located at it's request by resources residing on other programmed computer systems connected to the same public access communications network.

2. A method implemented on a programmed computer system where the method is given a plurality of lists of meta-data by a user residing on the same computer system where the system is connected to a public access communications network where the said meta-data:
a. Contains rules for directing the method in how to use resources contained on other programmed computer systems connected to public access communications networks through the use of secure communications devices requiring a protected sequence of operations to be performed to allow access outside of the secure private communications network.
b. Contains rules for directing the method in how to use resources residing on other programmed computer systems connected to the same public access communications network.
c. Contains rules for directing the method in how to filter the results of operations performed at it's request by resources residing on other programmed computer systems connected to the same public access communications network.
d. Contains rules for directing the method in how to contact owners of resources and objects located at it's request by resources residing on other programmed computer systems connected to the same public access communications network.
e. Contains rules for directing the method in how to negotiate for the use or ownership of said resources and objects located at it's request by resources residing on other programmed computer systems connected to the same public access communications network.

3. A method implemented on a programmed computer system where the method is given a plurality of lists of meta-data by a user residing on the same computer system where the system is connected to a secure private access communications network where the said meta-data:
a. Contains rules for directing the method in how to use resources contained on other programmed computer systems connected to public access communications networks through the use of secure communications devices requiring a protected sequence of operations to be performed to allow access outside of the secure private communications network.
b. Contains rules for directing the method in how to use resources contained on other programmed computer systems connected to public access communications networks through the use of secure communications devices requiring a protected sequence of operations to be performed to allow access outside of the secure private communications network.
c. Contains rules for directing the method in how to filter the results of operations performed at it's request by resources residing on other programmed computer systems connected to the same public access communications network.
d. Contains rules for directing the method in how to contact owners of resources and objects located at it's request by resources residing on other programmed computer systems connected to the same public access communications network.
e. Contains rules for directing the method in how to negotiate for the use or ownership of said resources and objects located at it's request by resources residing on other programmed computer systems connected to the same public access communications network.

4. A method implemented and distributed across a plurality of programmed computer systems connected to a plurality of communications networks where the method receives a plurality of lists of meta-data from a user residing on a computer system connected to one of the plurality of communications networks where the said meta-data:
a. Contains rules for directing the method in how to use resources contained on other programmed computer systems connected to secure private communications networks through the use of secure communications devices requiring a protected sequence of operations to be performed to allow access outside of the secure private communications network.
b. Contains rules for directing the method in how to use resources residing on other programmed computer systems connected to the same public access communications network.
c. Contains rules for directing the method in how to filter the results of operations performed at it's request by resources residing on other programmed computer systems connected to the same public access communications network.
d. Contains rules for directing the method in how to contact owners of resources and objects located at it's request by resources residing on other programmed computer systems connected to the same public access communications network.
e. Contains rules for directing the method in how to negotiate for the use or ownership of said resources and objects located at it's request by resources residing on other programmed computer systems connected to the same public access communications network.
